(19) United States
(12) Patent Application Publication
(10) Pub. No.: US 2019/0232897 A1
(43) Pub. Date: Aug. 1, 2019

(54) SLIDE DOOR ROUTING STRUCTURE

(71) Applicant: Yazaki Corporation, Tokyo (JP)

(72) Inventors: Kosuke Tomosada, Shizuoka (JP); Naoto Kogure, Shizuoka (JP)

(21) Appl. No.: 16/262,863

(22) Filed: Jan. 30, 2019

(30) Foreign Application Priority Data
Feb. 1, 2018 (JP) 2018-016427

(51) Int. Cl. B60R 16/02; E05D 15/06; B60R 16/027

(52) U.S. Cl. CPC B60R 16/0215; E05D 15/0621; B60J 5/06; E05Y 2900/531; B60R 16/027

(57) ABSTRACT

A slide door routing structure includes a flexible conductor electrically connecting a vehicle body side and a slide door having a slide portion guided by a guide unit provided on the vehicle body side and crossing a trajectory space through which the slide portion passes and a plate-shaped elastic body disposed along the conductor. A cross-sectional shape of the plate-shaped elastic body is a curved shape in which a first surface is a concave surface, and the plate-shaped elastic body is held such that a first curved portion is formed at a part crossing the trajectory space. Second curved portions are generated in the plate-shaped elastic body while the slide door moves from one to the other of a fully closed position and a fully open position.

### CROSS-REFERENCE TO RELATED APPLICATION(S)

The present application claims priority to and incorporates by reference the entire contents of Japanese Patent Application No. 2018-016427 filed in Japan on Feb. 1, 2018.

### BACKGROUND OF THE INVENTION

### 1. Field of the Invention

The present invention relates to a slide door routing structure.

### 2. Description of the Related Art

A technique for electrical connection between a slide door and a vehicle body side is known in the related art. Disclosed in Japanese Patent No. 4089059 is a slide door power supply mechanism electrically connecting a first functional component on a slide door side and a second functional component on a body side while displacing a curved part of a flexible portion in accordance with a slide door opening and closing operation. In Japanese Patent No. 4089059, a flexible conductor and a belt-shaped steel plate constitute the flexible portion. The flexible conductor has a feeder line electrically connecting the first and second functional components and an insulator covering the feeder line. The belt-shaped steel plate is arranged along the flexible conductor and has a concave surface in a vertical cross section in the slide direction of the slide door. The flexible portion is installed such that the concave surface of the belt-shaped steel plate is the outer peripheral side of the curved part.

According to the slide door power supply mechanism disclosed in Japanese Patent No. 4089059, the durability of the slide door power supply mechanism is improved and the degree of spatial freedom at a time of slide door power supply mechanism arrangement is improved.

The belt-shaped steel plate having the concave surface is likely to generate a sound during deformation from a linear shape to a curved shape and deformation from a curved shape to a linear shape. There is a problem that vehicular quietness is impaired once a sound is generated with deformation of the belt-shaped steel plate during slide door opening and closing.

### SUMMARY OF THE INVENTION

An object of the present invention is to provide a slide door routing structure capable of improving quietness at a time of slide door opening and closing.

According to one aspect of the present invention, a slide door routing structure includes a flexible conductor that electrically connects a vehicle body side and a slide door having a slide portion guided by a guide unit provided on the vehicle body side, and crosses a trajectory space through which the slide portion passes; and a plate-shaped elastic body disposed along the conductor, wherein a cross-sectional shape of the plate-shaped elastic body in a cross section orthogonal to an extending direction of the conductor is a curved shape in which a first surface as a surface on one side is a concave surface, both end portions of the plate-shaped elastic body are held such that a first curved portion is formed at a part of the plate-shaped elastic body crossing the trajectory space, a second curved portion different from the first curved portion is generated in the plate-shaped elastic body while the slide door moves from one to the other of a fully closed position and a fully open position, and the plate-shaped elastic body is curved with the first surface as an outer peripheral surface when viewed from a vehicle upward-downward direction in the first curved portion, and the plate-shaped elastic body is curved with the first surface as an inner peripheral surface when viewed from the vehicle upward-downward direction in the second curved portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a slide door routing structure according to an embodiment;

FIG. 2 is a cross-sectional view illustrating a slide portion and a guide unit according to the embodiment;

FIG. 3 is a perspective view illustrating the internal structure of a wire harness according to the embodiment;

FIG. 4 is a cross-sectional view of the wire harness according to the embodiment;

FIG. 5 is a cross-sectional view illustrating the wire harness and the guide unit according to the embodiment;

FIG. 6 is a diagram illustrating a balance of forces in the wire harness;

FIG. 7 is a diagram illustrating the shape of a curved portion;

FIG. 8 is a perspective view of a plate-shaped elastic body;

FIG. 9 is a diagram illustrating the relationship between the plate thickness and characteristics of the plate-shaped elastic body;

FIG. 10 is a diagram illustrating the relationship between the curvature radius and the characteristics of the plate-shaped elastic body;

FIG. 11 is a diagram illustrating the relationship between the number of stacked sheets and the characteristics of the plate-shaped elastic body;

FIG. 12 is a plan view illustrating the fully open state of a slide door;

FIG. 13 is a plan view illustrating the half open state of the slide door;

FIG. 14 is another plan view illustrating the half open state of the slide door;

FIG. 15 is a plan view illustrating the fully closed state of the slide door;

FIG. 16 is a perspective view illustrating sound generation during curvature deformation of the plate-shaped elastic body;

FIG. 17 is a diagram illustrating a change in the cross-sectional shape of the plate-shaped elastic body; and

FIG. 18 is a cross-sectional view of a wire harness according to a first modification example of the embodiment.

### DETAILED DESCRIPTION OF THE PREFERRED EMBODIMENTS

Hereinafter, a slide door routing structure according to an embodiment of the present invention will be described in detail with reference to accompanying drawings. It should be noted that the present invention is not limited by the embodiment. In addition, constituent elements in the following embodiment include those that can be easily assumed by those skilled in the art or those that are substantially identical.

### Embodiment

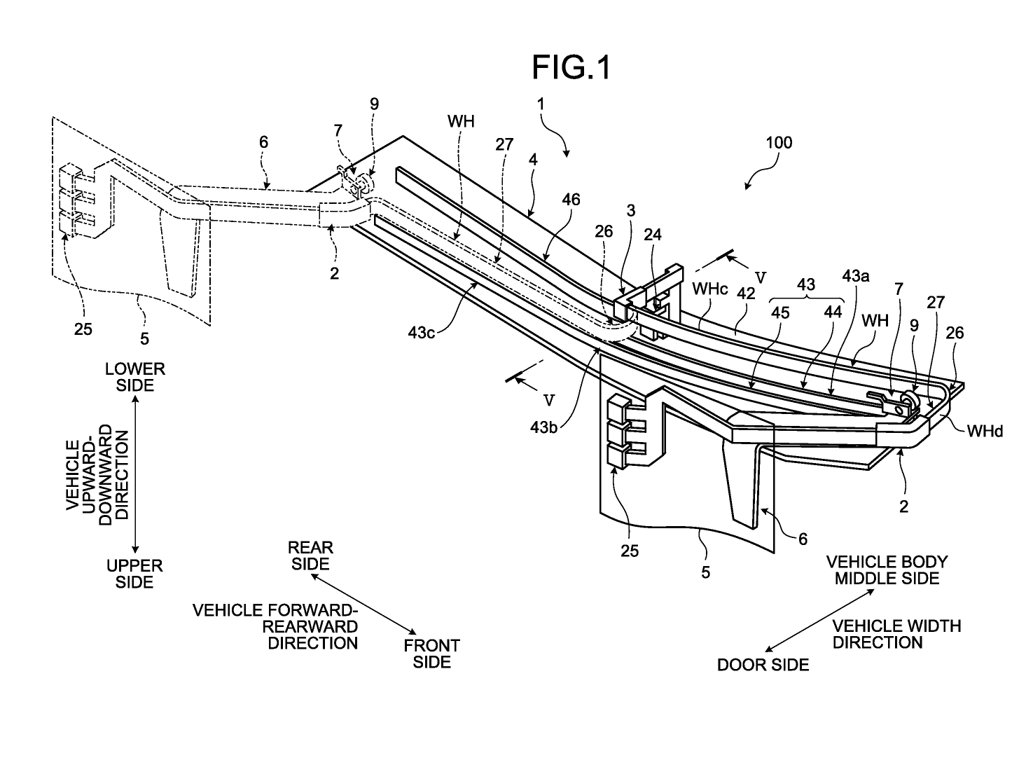

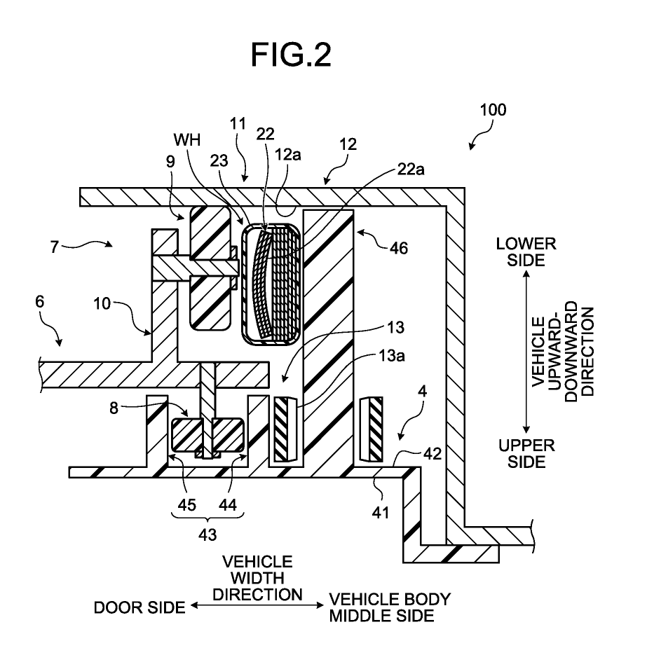

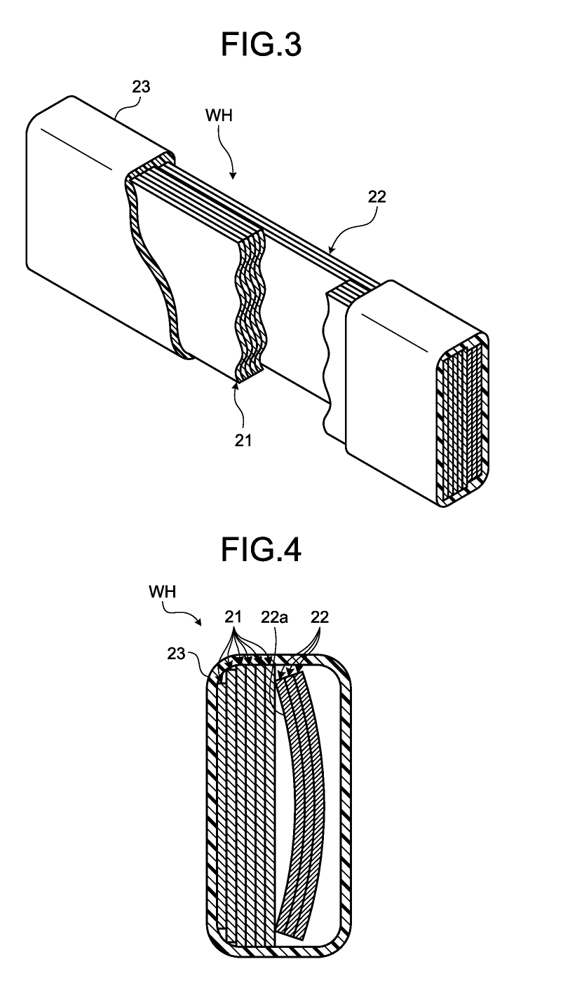

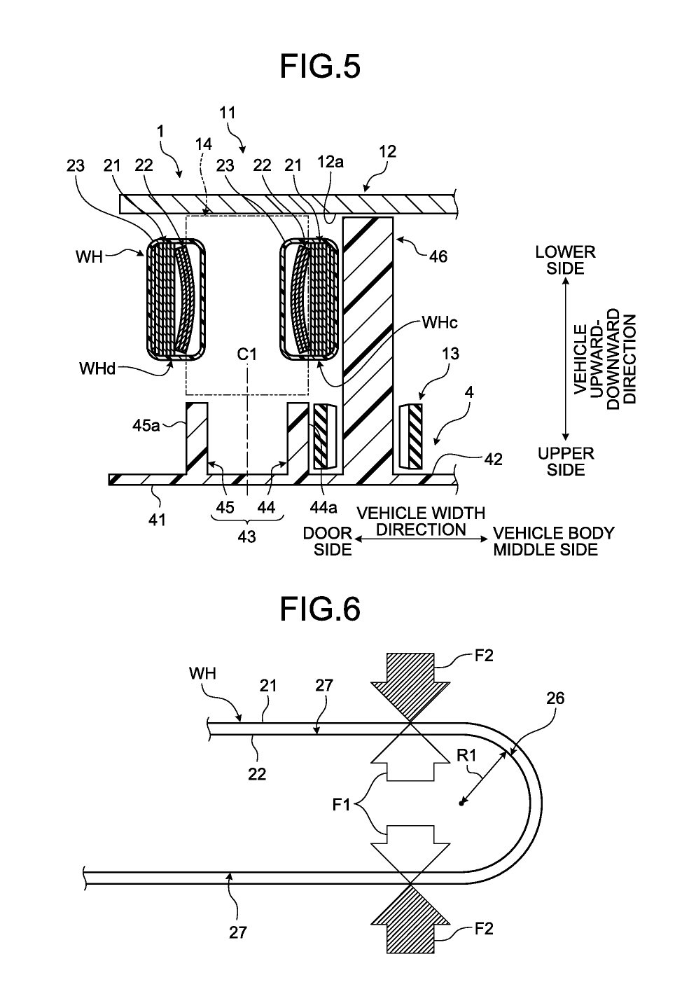

The embodiment will be described with reference to FIGS. 1 to 17. The present embodiment relates to a slide door routing structure. FIG. 1 is a perspective view illustrating a slide door routing structure according to the embodiment. FIG. 2 is a cross-sectional view illustrating a slide portion and a guide unit according to the embodiment. FIG. 3 is a perspective view illustrating the internal structure of a wire harness according to the embodiment. FIG. 4 is a cross-sectional view of the wire harness according to the embodiment. FIG. 5 is a cross-sectional view illustrating the wire harness and the guide unit according to the embodiment.

As illustrated in FIG. 1, a slide door routing structure 1 according to the present embodiment has a wire harness WH, a door side holding unit 2, a vehicle body side holding unit 3, and a partition wall 46. The wire harness WH is disposed in a step member 4 of a vehicle 100. The step member 4 is disposed in an opening portion of the vehicle 100. The opening portion is an opening portion provided in a vehicle body and is opened and closed by a slide door 5. The step member 4 is disposed in the lower end portion of the opening portion and is fixed to the vehicle body of the vehicle 100 such as a body panel 12 (see FIG. 2) to be described later. The step member 4 is molded with, for example, a synthetic resin. In the wire harness WH, the door side holding unit 2, the slide door 5, and a lower arm 6 illustrated in FIG. 1, solid lines indicate the fully closed state of the slide door 5 and an alternate long and two short dashes lines indicate the fully open state of the slide door 5.

In the step member 4, the surface on the vehicle upper side will be referred to as a surface 41 and the surface on the vehicle lower side will be referred to as a back surface 42. The wire harness WH is disposed on the back surface 42 side of the step member 4. A step side guide unit 43 is provided on the back surface 42 of the step member 4. The step side guide unit 43 guides a slide portion 7 disposed in the lower arm 6 of the slide door 5. The lower arm 6 is an arm fixed to the lower portion of the slide door 5. The slide portion 7 is provided in the vehicle body middle side tip portion of the lower arm 6.

FIG. 2 is a cross-sectional view of the position that is indicated by the V-V line of FIG. 1. Illustrated in FIG. 2 is a state where the slide portion 7 passes through the cross-sectional position. As illustrated in FIG. 2, the slide portion 7 has a first roller 8, a second roller 9, and a support unit 10. The support unit 10 is provided at the vehicle body middle side tip of the lower arm 6. The support unit 10 may be a member that is separate from the lower arm 6. The first roller 8 is disposed on the vehicle upper side in the support unit 10. The first roller 8 is supported by the support unit 10 so as to be rotatable around a rotation axis in the vehicle upward-downward direction. The second roller 9 is disposed on the vehicle lower side in the support unit 10. The second roller 9 is supported by the support unit 10 so as to be rotatable around a rotation axis in the vehicle width direction.

As illustrated in FIG. 2, the step side guide unit 43 protrudes toward the vehicle lower side from the back surface 42 of the step member 4. The step side guide unit 43 has a pair of wall portions 44 and 45 facing each other and is molded integrally with the main body of the step member 4. The step side guide unit 43 has a first wall portion 44 and a second wall portion 45. The first wall portion 44 is positioned closer to the vehicle body middle side than the second wall portion 45 in the vehicle width direction. The step side guide unit 43 extends along the vehicle forward-rearward direction. As illustrated in FIG. 1, the step side guide unit 43 is provided from the front side end portion to the rear side end portion of the step member 4 in the vehicle forward-rearward direction.

The step side guide unit 43 has a first linear portion 43a, a curved portion 43b, and a second linear portion 43c. The curved portion 43b connects the first linear portion 43a and the second linear portion 43c. In the step side guide unit 43, the first linear portion 43a is in front of the curved portion 43b in the vehicle forward-rearward direction. In the step side guide unit 43, the second linear portion 43c is behind the curved portion 43b in the vehicle forward-rearward direction. The first linear portion 43a is inclined with respect to the vehicle forward-rearward direction. More specifically, the first linear portion 43a is inclined toward the vehicle front side and the vehicle body middle side. By the first linear portion 43a being inclined, the slide door 5 moves to the vehicle body middle side and toward the vehicle front side and blocks the opening portion of the vehicle body. The shape of the curved portion 43b that is viewed from the vehicle upward-downward direction is a curved shape that is convex toward the door side in the vehicle width direction.

Referring back to FIG. 2, the first roller 8 is disposed in the space portion between the first wall portion 44 and the second wall portion 45. By being guided by the step side guide unit 43, the first roller 8 slides the slide door 5 along a predetermined trajectory.

The partition wall 46 is provided closer to the vehicle body middle side than the step side guide unit 43. The partition wall 46 is a rib-shaped wall portion protruding toward the vehicle lower side from the back surface 42 of the step member 4. The partition wall 46 is molded integrally with the main body of the step member 4. The partition wall 46 is provided along the step side guide unit 43 from the vehicle front side end portion to the vehicle rear side end portion of the step member 4. A passage of a belt 13 is formed between the partition wall 46 and the first wall portion 44. The belt 13 is an endless belt made of rubber or the like. The belt 13 is disposed so as to surround the partition wall 46. Projections 13a are formed at regular intervals on the inner peripheral surface of the loop-shaped belt 13. The slide portion 7 is connected to the belt 13 and is driven by a rotational movement of the belt 13 to move in the vehicle forward-rearward direction. A motor (not illustrated) is disposed on the surface 41 side of the step member 4. The belt 13 is connected to the motor via a sprocket or the like and is driven by the motor to perform circling.

The body panel 12 is positioned below the step member 4. The body panel 12 has a support surface 12a facing the back surface 42 of the step member 4. The body panel 12 is fixed to the vehicle body and supports the second roller 9 from below. In other words, the second roller 9 moves in the vehicle forward-rearward direction while rolling on the support surface 12a of the body panel 12 and is guided by the support surface 12a. The body panel 12 and the step side guide unit 43 constitute a guide unit 11 guiding the slide portion 7.

The wire harness WH electrically connects the vehicle body side of the vehicle 100 and the slide door 5. As illustrated in FIGS. 1 and 3, the wire harness WH has a flexible flat cable (FFC) 21, a plate-shaped elastic body 22, an exterior package 23, a first connector 24, and a second connector 25. The FFC 21 is a flexible and flat electrical connection member. The FFC 21 is a conductor covered by an insulating coating. The conductor is made of a conductive metal such as copper and aluminum. The wire harness WH of the present embodiment has a plurality of the FFCs 21. The plurality of FFCs 21 is stacked in the thickness direction. The FFC 21 is a power line or a signal line connecting the vehicle body side and the slide door 5.

The plate-shaped elastic body 22 is a plate-shaped member having elasticity. As illustrated in FIG. 4, the cross section of the plate-shaped elastic body 22 orthogonal to the axial direction of the FFC 21 has a curved shape. The cross-sectional shape of the plate-shaped elastic body 22 is a curved shape convex toward one side in the plate thickness direction. Of the two surfaces of the plate-shaped elastic body 22 in the following description, the surface on the side that becomes a concave surface in the cross-sectional shape will be referred to as a “first surface 22a” and the surface on the side that becomes a convex surface will be referred to as a “second surface 22b”. The plate-shaped elastic body 22 is curved such that the first surface 22a becomes a concave surface in a case where no external force acts on the plate-shaped elastic body 22. The plate-shaped elastic body 22 is configured such that a restoring force to restore the above-mentioned curved shape is generated. The plate-shaped elastic body 22 of the present embodiment is so-called convex steel and is a metal plate previously formed in the curved shape. The wire harness WH of the present embodiment has a plurality of the plate-shaped elastic bodies 22. Each of the plurality of plate-shaped elastic bodies 22 overlaps each other with the first surfaces 22a facing the same side.

The plate-shaped elastic body 22 and the FFC 21 are accommodated in the flexible exterior package 23. The exterior package 23 is tubular and formed of, for example, an insulating synthetic resin. The exterior package 23 of the present embodiment is a so-called corrugated tube and formed in a bellows shape. The cross-sectional shape of the exterior package 23 is substantially rectangular, and the external dimension in the vehicle upward-downward direction is larger than the external dimension in the vehicle width direction. The exterior package 23 suppresses sagging of the FFC 21 and the plate-shaped elastic body 22 and is capable of suppressing vibration of the wire harness WH in the vehicle upward-downward direction. The cross-sectional shape of the exterior package 23 of the present embodiment is a rectangular shape and the longitudinal direction of the shape is the vehicle upward-downward direction. Accordingly, the exterior package 23 has a large rigidity with respect to deflection in the vehicle upward-downward direction. Therefore, in the exterior package 23 of the present embodiment, the amount of deflection in the vehicle upward-downward direction is reduced.

As illustrated in FIG. 4, the plurality of FFCs 21 and the plurality of plate-shaped elastic bodies 22 are accommodated and held in the exterior package 23. The internal dimension of the exterior package 23 in the vehicle upward-downward direction is equal to the width of the FFC 21. The width of the plate-shaped elastic body 22 is slightly smaller than the width of the FFC 21. The plurality of stacked plate-shaped elastic bodies 22 is disposed so as to overlap one side surface of the plurality of stacked FFCs 21. In the present embodiment, the plate-shaped elastic body 22 is accommodated in the exterior package 23 with the first surface 22a facing the FFC 21. In other words, the cross-sectional shape of the plate-shaped elastic body 22 is a curved shape convex toward the side opposite to the FFC 21 side.

The first connector 24 is connected to one end of the FFC 21. The second connector 25 is connected to the other end of the FFC 21. The first connector 24 is connected with a connector on a vehicle body side in the vehicle width direction that is closer to the vehicle body middle side than the step side guide unit 43. The second connector 25 is connected with the connector of the slide door 5 on the side in the vehicle width direction that is closer to the slide door 5 side than the step side guide unit 43. The wire harness WH connects the vehicle body side and the slide door 5 across the step side guide unit 43. More specifically, the wire harness WH is routed across the space between the protruding direction tip of the step side guide unit 43 and the body panel 12 in the vehicle width direction. In other words, the wire harness WH connects the slide door 5 and the vehicle body side across a trajectory space 14 (see FIG. 5) through which the slide portion 7 passes.

As illustrated in FIG. 1, one end side of the wire harness WH is held by the vehicle body side holding unit 3. The vehicle body side holding unit 3 is fixed to, for example, the back surface 42 of the step member 4. The vehicle body side holding unit 3 is disposed in the middle portion of the step member 4 in the vehicle forward-rearward direction. In addition, the vehicle body side holding unit 3 is disposed in the middle portion of the movement range in which the slide portion 7 moves in the vehicle forward-rearward direction.

The vehicle body side holding unit 3 of the present embodiment holds the wire harness WH in a posture bent at a substantially right angle. The part of the wire harness WH that is closer to the slide door 5 side than the vehicle body side holding unit 3 extends from the vehicle body side holding unit 3 toward the vehicle front side. The vehicle body side holding unit 3 holds the wire harness WH such that, for example, the FFC 21 and the plate-shaped elastic body 22 extend in parallel to the step side guide unit 43. The part of the wire harness WH that is closer to the vehicle body side than the vehicle body side holding unit 3 extends from the vehicle body side holding unit 3 toward the vehicle body middle side.

The other end side of the wire harness WH is held by the door side holding unit 2. The door side holding unit 2 is fixed to the lower arm 6. The door side holding unit 2 of the present embodiment holds the wire harness WH in a posture bent at an obtuse angle. The part of the wire harness WH that is closer to the vehicle body side than the door side holding unit 2 extends from the door side holding unit 2 toward the vehicle body middle side. The part of the wire harness WH that is closer to the door panel side of the slide door 5 than the door side holding unit 2 extends from the door side holding unit 2 along one side of the lower arm 6. The plate-shaped elastic body 22 is not disposed at the part of the wire harness WH of the present embodiment that is closer to the door panel side than the door side holding unit 2. In other words, the plate-shaped elastic body 22 is disposed in the range of the wire harness WH from the door side holding unit 2 to the vehicle body side holding unit 3.

As illustrated in FIG. 1, a first curved portion 26 is formed in the wire harness WH. The first curved portion 26 is a curved part deformed such that the central axis of the wire harness WH is curved. In other words, the first curved portion 26 is a part of the wire harness WH that is curved when viewed from the vehicle upward-downward direction. The first curved portion 26 is also a bent portion in which the extending direction of the wire harness WH changes. The first curved portion 26 is formed in the trajectory space 14 illustrated in FIG. 5. FIG. 5 illustrates the V-V cross section of FIG. 1. The wire harness WH illustrated in FIG. 5 is the wire harness WH that is fully open, that is, in the state indicated by the alternate long and two short dashes lines in FIG. 1. The trajectory space 14 is a space portion through which the slide portion 7 of the slide door 5 passes. As illustrated in FIG. 5, the trajectory space 14 in the present embodiment is a space between the protruding direction tip of the step side guide unit 43 and the body panel 12. The first curved portion 26 is formed such that at least a part of the first curved portion 26 is positioned in the trajectory space 14.

The range of the trajectory space 14 in the vehicle upward-downward direction is typically a range below the step side guide unit 43 and above the body panel 12. The range of the trajectory space 14 in the vehicle width direction is typically a range including the step side guide unit 43. More specifically, the range including the step side guide unit 43 is a range from the vehicle body middle side surface of the first wall portion 44 to the door side surface of the second wall portion 45. The trajectory space 14 may include a range on the side that is closer to the vehicle body middle side than the first wall portion 44 or may include a range on the side that is closer to the door side than the second wall portion 45.

The wire harness WH is folded back in the first curved portion 26. In other words, the wire harness WH extending from the vehicle body side holding unit 3 toward the vehicle front side is bent toward the vehicle rear side or the door side in the vehicle width direction in the first curved portion 26. In the state indicated by the alternate long and two short dashes lines in FIG. 1, that is, the fully open state of the slide door 5, for example, the wire harness WH extending from the vehicle body side holding unit 3 toward the vehicle front side is folded back toward the vehicle rear side in the first curved portion 26. Each of the parts of the wire harness WH that are connected to the first curved portion 26 extends in the vehicle forward-rearward direction along the step side guide unit 43.

In the state indicated by the solid line in FIG. 1, that is, the fully closed state of the slide door 5, the wire harness WH extending from the vehicle body side holding unit 3 toward the vehicle front side is folded back toward the door side in the vehicle width direction in the first curved portion 26. In this manner, the extending direction of the part closer to the door side than the first curved portion 26 varies with the position of the slide door 5. In the fully closed state of the slide door 5, at least a part WHc of the wire harness WH closer to the vehicle body side than the first curved portion 26 extends in the vehicle forward-rearward direction along the step side guide unit 43.

The part WHc of the wire harness WH closer to the vehicle body side than the first curved portion 26 extends along the partition wall 46. The door side holding unit 2 of the present embodiment extends the wire harness WH toward the vehicle body middle side, that is, toward the partition wall 46 such that the wire harness WH extends along the partition wall 46. By the wire harness WH extending from the door side holding unit 2 toward the vehicle body middle side, the part WHc of the wire harness WH closer to the vehicle body side than the first curved portion 26 is pressed toward the partition wall 46. Due to this pressing force, the part WHc of the wire harness WH closer to the vehicle body side than the first curved portion 26 deforms in accordance with the shape of the partition wall 46 and extends along the partition wall 46. In addition, the relative position where the first curved portion 26 is formed with respect to the partition wall 46 is determined by this pressing force. In other words, the first curved portion 26 is formed such that one end of the first curved portion 26 is in contact with the partition wall 46.

As illustrated in FIG. 5, in the wire harness WH of the present embodiment, the vehicle body side part WHc of the folded wire harness WH is positioned on an extension line of the first wall portion 44 and a door side part WHd is positioned on an extension line of the second wall portion 45. In other words, the first curved portion 26 is curved about a center line C1 of the step side guide unit 43. In addition, the wire harness WH is curved in the first curved portion 26 so as to be symmetrical or substantially symmetrical in relation to the center line C1. The plate-shaped elastic body 22 is configured such that the first curved portion 26 is formed in the trajectory space 14 and the first curved portion 26 is curved with the above-described shape. The plate thickness, the curved shape, the material, the number of installed sheets, and so on of the plate-shaped elastic body 22 are determined such that the first curved portion 26 is formed in the trajectory space 14 and the first curved portion 26 is curved with the above-described shape.

As illustrated in FIG. 5, the part WHc of the wire harness WH closer to the vehicle body side than the first curved portion 26 and the part WHd of the wire harness WH closer to the door side than the first curved portion 26 face each other in the vehicle width direction. At each of the parts WHc and WHd, the plate-shaped elastic body 22 is positioned inside the FFC 21. In other words, at the vehicle body side part WHc, the plate-shaped elastic body 22 is positioned on the side that is closer to the door side part WHd than the FFC 21. Likewise, at the door side part WHd, the plate-shaped elastic body 22 is positioned on the side that is closer to the vehicle body side part WHc than the FFC 21. In this manner, in the wire harness WH of the present embodiment, the plate-shaped elastic body 22 is disposed in the first curved portion 26 so as to be positioned on the curvature direction inner side with respect to the FFC 21.

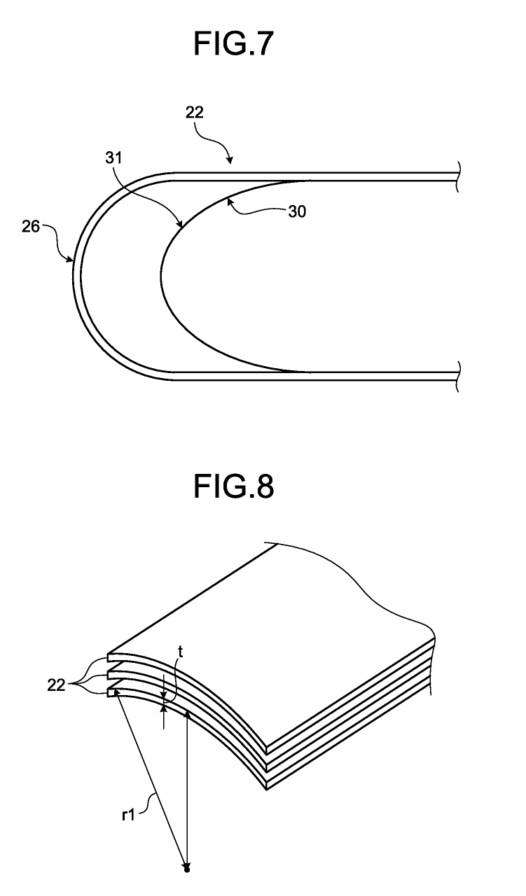

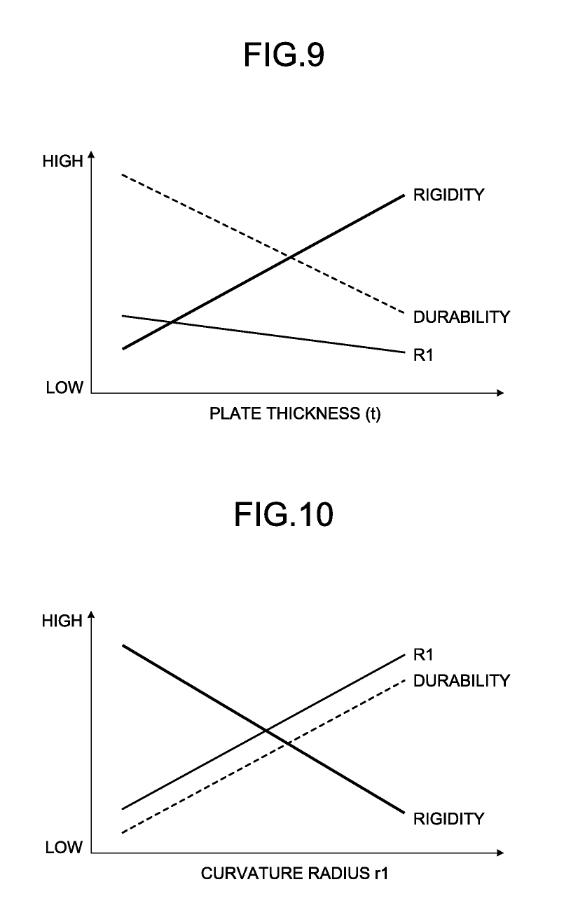

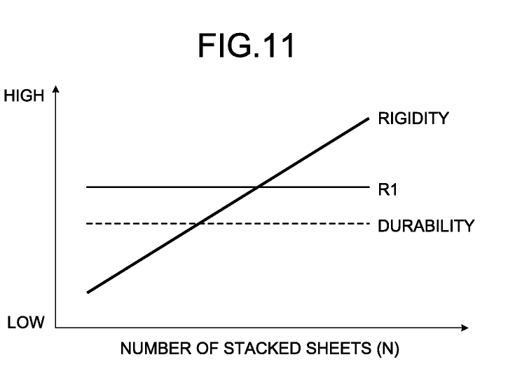

The plate-shaped elastic body 22 will be described in more detail. FIG. 6 is a diagram illustrating a balance of forces in the wire harness. FIG. 7 is a diagram illustrating the shape of the curved portion. FIG. 8 is a perspective view of the plate-shaped elastic body. FIG. 9 is a diagram illustrating the relationship between the plate thickness and characteristics of the plate-shaped elastic body. FIG. 10 is a diagram illustrating the relationship between the curvature radius and the characteristics of the plate-shaped elastic body. FIG. 11 is a diagram illustrating the relationship between the number of stacked sheets and the characteristics of the plate-shaped elastic body.

As illustrated in FIG. 6, a repulsive force F1 is generated in the FFC 21 bent into a curved shape. The repulsive force F1 is a restoring force causing the FFC 21 to return to a linear shape. The magnitude of the repulsive force F1 depends on the rigidity of the FFC 21 and the like. The plate-shaped elastic body 22 generates a holding force F2 commensurate with the repulsive force F1 of the FFC 21. The holding force F2 is a force in a direction to maintain the FFC 21 in a curved shape against the repulsive force F1. The holding force F2 is transmitted to the FFC 21 via, for example, the exterior package 23. The maximum value of the holding force F2 is determined by, for example, the rigidity of the plate-shaped elastic body 22. The plate-shaped elastic body 22 of the present embodiment is configured to be capable of forming the first curved portion 26 having at least a desired radius and generating the holding force F2 commensurate with the repulsive force F1 at a time when the first curved portion 26 is formed.

An example of a method for giving desired characteristics to the plate-shaped elastic body 22 will be described. As illustrated in FIG. 7, the plate-shaped elastic body 22 has a stable curved shape when bent. In FIG. 7, the plate-shaped elastic body 22 and a flat steel plate 30 as a comparative example are illustrated. The flat steel plate 30 is a steel plate having a rectangular cross-sectional shape. A curved portion 31 is formed when the flat steel plate 30 is bent. The shape of the curved portion 31 is a parabolic curve. The arc-shaped first curved portion 26 is formed when the plate-shaped elastic body 22 is bent. The plate-shaped elastic body 22 has, in advance, a curved shape that is convex toward one side in the plate thickness direction. As a result, the radius of the arc of the first curved portion 26 tends to be uniform along the circumferential direction.

The characteristics of the plate-shaped elastic body 22 can be adjusted by, for example, a plate thickness t and a curvature radius r1 illustrated in FIG. 8 and the number N of stacked plate-shaped elastic bodies 22. The plate thickness t is the thickness of one plate-shaped elastic body 22. The curvature radius r1 is the radius of the curved shape previously given to the plate-shaped elastic body 22. The cross section of the plate-shaped elastic body 22 that is orthogonal to the longitudinal direction of the plate-shaped elastic body 22 is arcuate or substantially arcuate. The curvature radius r1 is, for example, the radius of the arc shape that is formed by the outer peripheral surface of the plate-shaped elastic body 22. The number N of stacked sheets is the number of stacked plate-shaped elastic bodies 22.

In FIG. 9, the horizontal axis represents the plate thickness t. Illustrated in FIG. 9 are the rigidity, the durability, and a bending radius R1 of one plate-shaped elastic body 22. The rigidity is, for example, bending rigidity with respect to bending to form the first curved portion 26. This rigidity is also rigidity maintaining the shape of the FFC 21 with respect to the repulsive force F1. The durability is durability with respect to repeated bending. As illustrated in FIG. 6, the bending radius R1 is the radius of the arc shape of the first curved portion 26 to be formed. As is apparent from FIG. 9, the rigidity increases as the plate thickness t increases. The durability decreases and the bending radius R1 decreases as the plate thickness t increases.

In FIG. 10, the horizontal axis represents the curvature radius r1. As in FIG. 9, the rigidity, the durability, and the bending radius R1 of one plate-shaped elastic body 22 are illustrated in FIG. 10. The rigidity decreases as the curvature radius r1 increases. The durability improves and the bending radius R1 increases as the curvature radius r1 increases.

In FIG. 11, the horizontal axis represents the number N of stacked sheets. The rigidity illustrated in FIG. 11 is the rigidity of the laminate of the plate-shaped elastic bodies 22 that depends on the number N of stacked sheets. In FIG. 11, the durability is the durability of each plate-shaped elastic body 22 and the bending radius R1 is the bending radius R1 of the laminate of the plate-shaped elastic bodies 22. The bending radius R1 of the laminate is, for example, the bending radius R1 of the innermost plate-shaped elastic body 22 in the laminate. As is apparent from FIG. 11, the rigidity of the laminate increases as the number N of stacked sheets increases. The durability and the bending radius R1 are constant or substantially constant irrespective of the number N of stacked sheets.

As illustrated in FIGS. 9 and 10, both the plate thickness t and the curvature radius r1 affect all of the rigidity, the durability, and the bending radius R1. Further, for both the plate thickness t and the curvature radius r1, there is a contradiction that the durability is lowered when the rigidity is improved. In the present embodiment, a combination of the plate thickness t and the curvature radius r1 of each plate-shaped elastic body 22 is determined such that a desired bending radius R1 and a desired durability are realized. In addition, the number N of stacked plate-shaped elastic bodies 22 is determined such that a desired rigidity is realized. In this manner, the laminate of the plate-shaped elastic bodies 22 according to the present embodiment has a desired bending radius R1, a desired durability, and a desired rigidity.

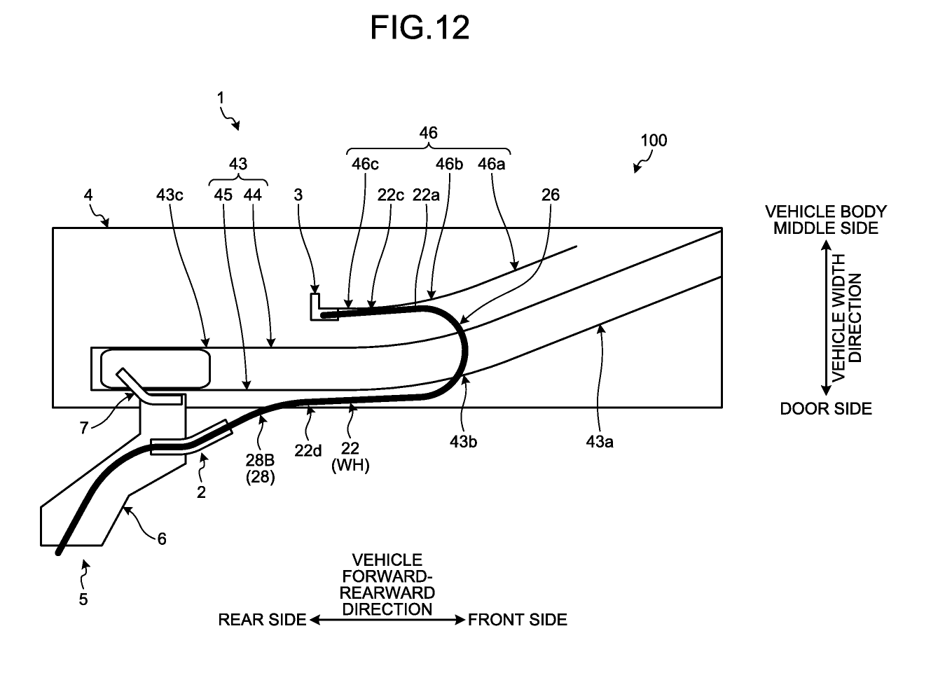

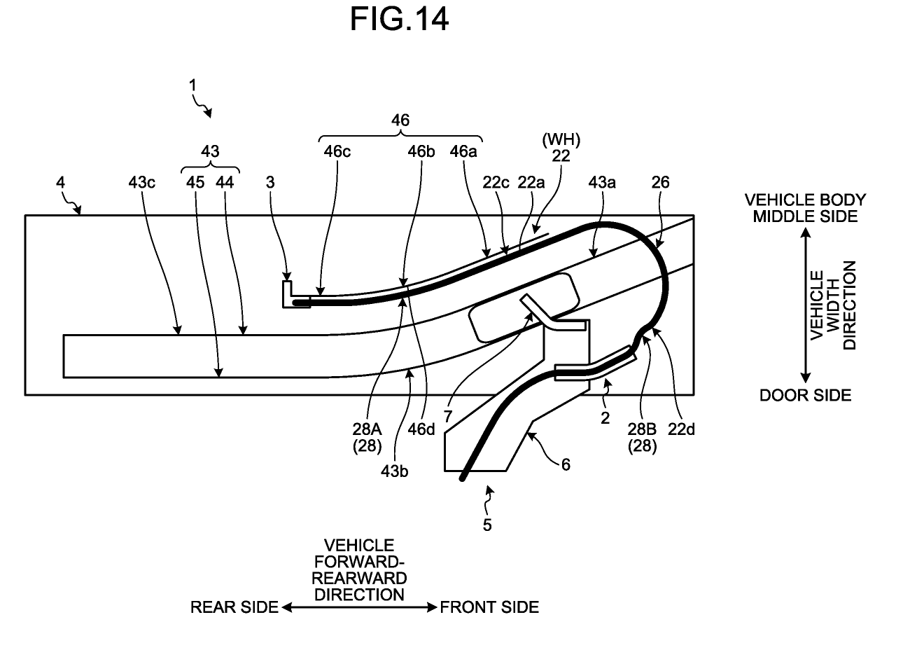

In the slide door routing structure 1 of the present embodiment, a second curved portion 28 different from the first curved portion 26 is generated when the slide door 5 is opened and closed. As will be described below, when the slide door 5 is opened and closed, two second curved portions 28 (vehicle body side second curved portion 28A and door side second curved portion 28B) are generated in the plate-shaped elastic body 22 (see FIG. 14). In response to the curvature of the plate-shaped elastic body 22, two second curved portions 28 are generated in the wire harness WH as well. In FIGS. 12 to 15, illustration of the exterior package 23 and the FFC 21 is omitted for description of the curved shape of the plate-shaped elastic body 22.

The vehicle body side second curved portion 28A is generated at a part 22c of the plate-shaped elastic body 22 closer to the vehicle body side than the first curved portion 26. The door side second curved portion 28B is generated at a part 22d of the plate-shaped elastic body 22 closer to the door side than the first curved portion 26. As will be described below, the vehicle body side second curved portion 28A is formed by the partition wall 46 having a curved shape.

As illustrated in FIG. 12 and so on, the partition wall 46 has a first linear portion 46a, a curved portion 46b, and a second linear portion 46c. The curved portion 46b connects the first linear portion 46a and the second linear portion 46c. The first linear portion 46a is a part of the partition wall 46 in front of the curved portion 46b in the vehicle forward-rearward direction. The second linear portion 46c is a part of the partition wall 46 behind the curved portion 46b in the vehicle forward-rearward direction.

The first linear portion 46a extends along the first linear portion 43a of the step side guide unit 43. The first linear portion 46a is substantially parallel to the first linear portion 43a. The second linear portion 46c extends along the second linear portion 43c of the step side guide unit 43. The second linear portion 46c is substantially parallel to the second linear portion 43c. The shape of the curved portion 46b that is viewed from the vehicle upward-downward direction is a curved shape convex toward the door side in the vehicle width direction. The curved portion 46b is curved so as to head toward the vehicle body middle side from the second linear portion 46c toward the first linear portion 46a. The curved portion 46b is substantially parallel to the curved portion 43b of the step side guide unit 43.

As illustrated in FIG. 12, in the fully open state of the door, the vehicle body side second curved portion 28A is absent in the plate-shaped elastic body 22. As illustrated in FIG. 14, the vehicle body side second curved portion 28A is generated in the plate-shaped elastic body 22 during a movement of the slide door 5 from the fully open position to the fully closed position. When the second curved portion 28 is generated, a sound may be generated by the linear plate-shaped elastic body 22 being curved and deformed. As will be described below, the plate-shaped elastic body 22 of the present embodiment is configured such that no sound is likely to be generated when the second curved portion 28 is generated.

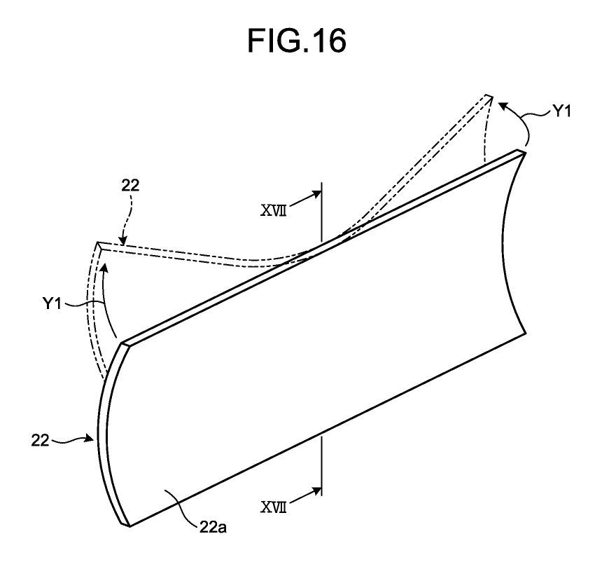

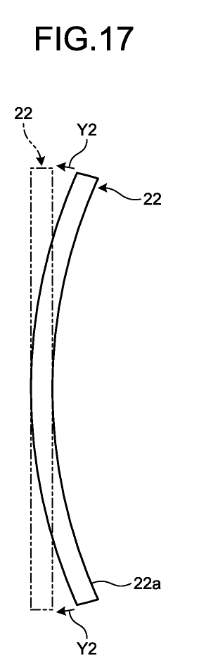

First, sound generation during curvature deformation of the plate-shaped elastic body 22 will be described with reference to FIGS. 16 and 17. FIG. 17 illustrates the XVII-XVII cross section of FIG. 16. It is assumed that the plate-shaped elastic body 22 is bent in the direction indicated by the arrow Y1 in FIG. 16. In FIG. 16, the linear plate-shaped elastic body 22 is indicated by a solid line and the bent plate-shaped elastic body 22 is indicated by an alternate long and two short dashes lines. The bent plate-shaped elastic body 22 is curved such that the first surface 22a is the outer peripheral surface.

In a case where the plate-shaped elastic body 22 is bent with the first surface 22a as the outer peripheral surface, abrupt deformation occurs in the curved portion. In other words, while the magnitude of the bending moment acting on the plate-shaped elastic body 22 is less than a predetermined value, the plate-shaped elastic body 22 maintains a linear shape against the bending moment and does not bend. The plate-shaped elastic body 22 is bent once the magnitude of the bending moment acting on the plate-shaped elastic body 22 reaches the predetermined value. This bending deformation proceeds in a short time as if buckling. As indicated by the arrow Y2 in FIG. 17, in the curved portion, the cross-sectional shape changes from a curved shape to a substantially linear shape. When the plate-shaped elastic body 22 is bent, a sound is generated by the abrupt deformation. Even in a case where the plate-shaped elastic body 22 undergoes a transition from a curved shape to a linear shape, the cross-sectional shape is abruptly changed by the restoring force of the plate-shaped elastic body 22 and a sound is generated.

As described above, a sound is generated in the plate-shaped elastic body 22 in a case where a curved portion in which the first surface 22a is the outer peripheral surface is generated or in a case where the generated curved portion returns to a linear shape. Quietness may be impaired in the vehicle 100 once the sound is generated from the plate-shaped elastic body 22 during opening and closing of the slide door 5.

As will be described below, the slide door routing structure 1 of the present embodiment is configured such that the curved portion in which the first surface 22a is the outer peripheral surface is not generated anew in the plate-shaped elastic body 22 during opening and closing of the slide door 5. Specifically, the slide door routing structure 1 of the present embodiment is configured such that the plate-shaped elastic body 22 is curved in the second curved portion 28 with the first surface 22a as an inner peripheral surface. In other words, the second curved portion 28 is curved with the convex side surface of the cross-sectional shape as the outer peripheral surface. In this case, no abrupt change in shape is likely to occur when the plate-shaped elastic body 22 is bent. Therefore, with the slide door routing structure 1 of the present embodiment, sound generation from the plate-shaped elastic body 22 can be suppressed.

Such a difference in deformation characteristics is, for example, that the magnitude of the bending resistance of the plate-shaped elastic body 22 varies with the direction of curvature. The bending resistance is smaller in a case where the plate-shaped elastic body 22 is curved with the first surface 22a as the inner peripheral surface than in a case where the plate-shaped elastic body 22 is curved with the first surface 22a as the outer peripheral surface. In other words, the plate-shaped elastic body 22 is bent with a smaller bending moment in a case where the plate-shaped elastic body 22 is curved with the first surface 22a as the inner peripheral surface than in a case where the plate-shaped elastic body 22 is curved with the first surface 22a as the outer peripheral surface. As a result, no sound is likely to be generated when the second curved portion 28 is generated.

Deformation of the plate-shaped elastic body 22 during opening and closing of the slide door 5 will be described with reference to FIGS. 12 to 15. FIG. 12 illustrates the fully open state of the slide door 5. In the fully open state, the first curved portion 26 and the door side second curved portion 28B are formed in the plate-shaped elastic body 22. The door side second curved portion 28B is formed in the vicinity of the door side holding unit 2. The plate-shaped elastic body 22 extends from the door side holding unit 2 toward the vehicle body middle side and changes its direction in the door side second curved portion 28B. The door side part 22d of the plate-shaped elastic body 22 linearly extends along the vehicle forward-rearward direction from the door side second curved portion 28B to the first curved portion 26.

The vehicle body side second curved portion 28A is absent in the fully open state of the slide door 5. The vehicle body side part 22c of the plate-shaped elastic body 22 linearly extends along the vehicle forward-rearward direction from the vehicle body side holding unit 3 to the first curved portion 26.

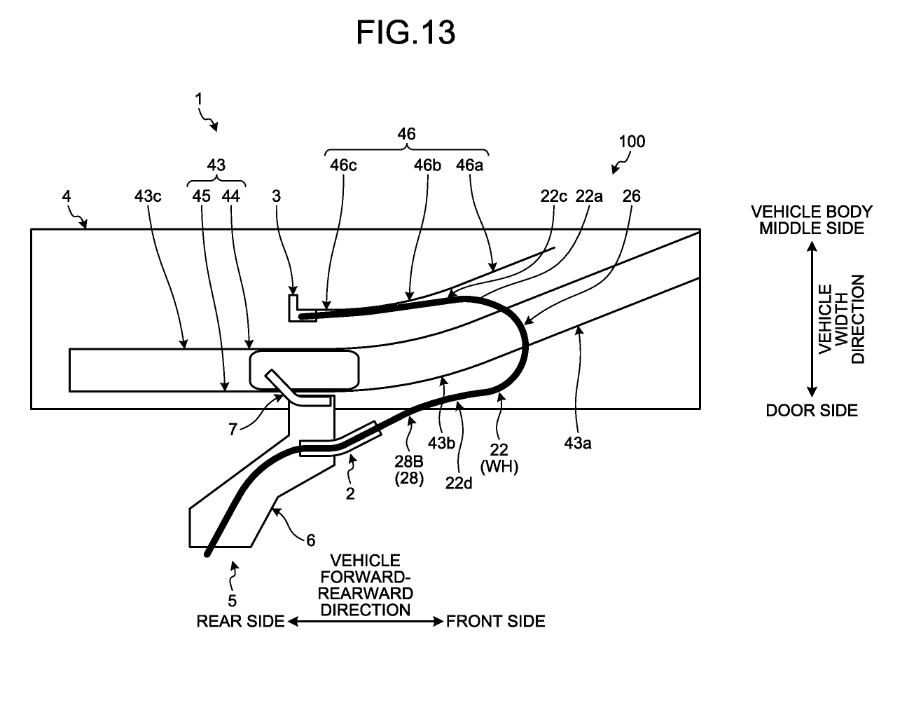

Illustrated in FIG. 13 is a state where the slide door 5 has moved to the front side in the vehicle forward-rearward direction from the fully open position. The slide portion 7 is guided by the second linear portion 43c of the step side guide unit 43 and moves straight along the vehicle forward-rearward direction. The vehicle body side part 22c of the plate-shaped elastic body 22 linearly extends along the second linear portion 46c of the partition wall 46. In the state illustrated in FIG. 13, the vehicle body side second curved portion 28A is not yet to be generated.

Illustrated in FIG. 14 is a state where the slide door 5 has moved to the front side in the vehicle forward-rearward direction from the position in FIG. 13. The slide portion 7 is guided by the first linear portion 43a of the step side guide unit 43. The slide portion 7 guided by the first linear portion 43a gradually moves toward the vehicle body middle side in the vehicle width direction. In accordance with the movement of the slide portion 7, the vehicle body side part 22c of the plate-shaped elastic body 22 is pressed toward the curved portion 46b of the partition wall 46. As a result, the vehicle body side part 22c is bent and the vehicle body side second curved portion 28A is generated. The vehicle body side second curved portion 28A is bent along the curved portion 46b of the partition wall 46. In other words, the plate-shaped elastic body 22 is bent along a curved surface 46d of the partition wall 46. The curved surface 46d is the convex side surface of the curved portion 46b, that is, a surface facing the plate-shaped elastic body 22.

The concave first surface 22a of the plate-shaped elastic body 22 of the present embodiment faces the partition wall 46. Accordingly, the plate-shaped elastic body 22 gradually bends along the curved surface 46d in accordance with an increase in the pressing force received from the slide portion 7. In other words, abrupt bending deformation hardly occurs in the plate-shaped elastic body 22. Therefore, no sound is likely to be generated from the plate-shaped elastic body 22 when the vehicle body side second curved portion 28A is generated.

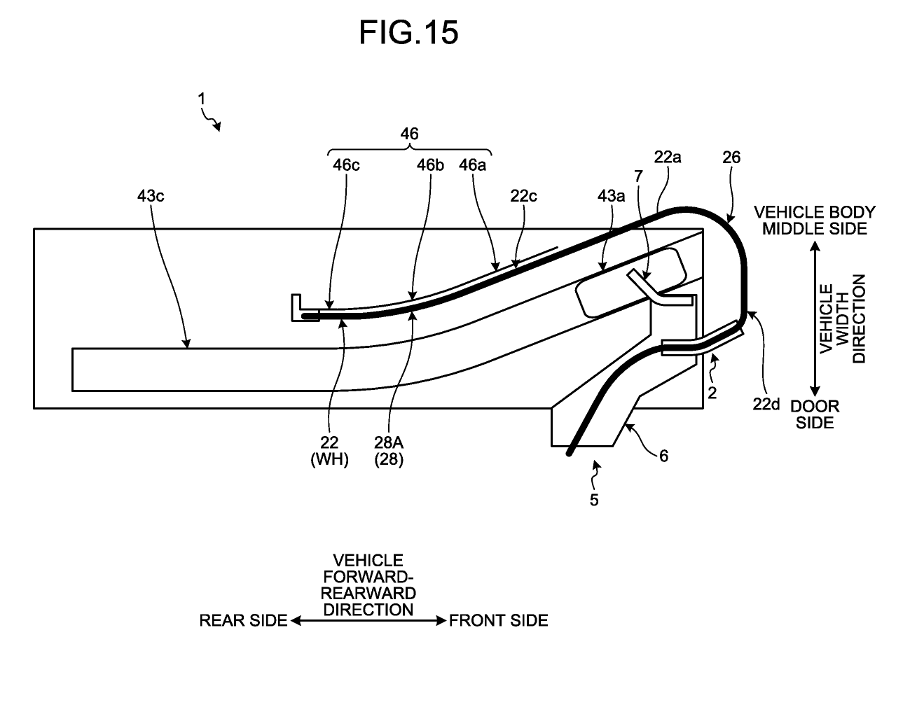

Illustrated in FIG. 15 is the fully closed state of the slide door 5. The door side second curved portion 28B is absent in the fully closed state. In other words, the door side second curved portion 28B disappears from the door side part 22d until the slide door 5 is fully closed. The door side part 22d linearly extends from the door side holding unit 2 to the first curved portion 26. In the slide door routing structure 1 of the present embodiment, the door side second curved portion 28B is curved with the first surface 22a as the inner peripheral surface. Therefore, no sound is likely to be generated from the plate-shaped elastic body 22 when the door side second curved portion 28B linearly deforms.

In a case where the slide door 5 moves from the fully closed position (FIG. 15) to the fully open position (FIG. 12), deformation opposite to the above occurs in the plate-shaped elastic body 22. In other words, the door side second curved portion 28B is generated in the plate-shaped elastic body 22 while the slide door 5 moves from the fully closed position illustrated in FIG. 15 to the position illustrated in FIG. 14. In addition, the vehicle body side second curved portion 28A disappears from the plate-shaped elastic body 22 while the slide door 5 moves from the position illustrated in FIG. 14 to the position illustrated in FIG. 13. No sound is likely to be generated from the plate-shaped elastic body 22 when the door side second curved portion 28B is generated and when the vehicle body side second curved portion 28A disappears alike. Therefore, according to the slide door routing structure 1 of the present embodiment, sound generation during opening and closing of the slide door 5 is suppressed.

The slide door routing structure 1 of the present embodiment is configured such that the curved portion in which the first surface 22a is the outer peripheral surface is not generated anew in the plate-shaped elastic body 22 during opening and closing of the slide door 5. In other words, the curved portions generated in the plate-shaped elastic body 22 when the slide door 5 is opened and closed are the second curved portion 28 without exception and are curved with the first surface 22a as an inner peripheral side surface. As such a configuration, in the present embodiment, the curved portion 46b of the partition wall 46 is convex toward the wire harness WH. In addition, as such a configuration, in the present embodiment, the door side holding unit 2 holds the plate-shaped elastic body 22 so as to extend the plate-shaped elastic body 22 toward the vehicle body middle side.

As described above, the slide door routing structure 1 according to the present embodiment has the FFC 21, which is a flexible conductor, and the plate-shaped elastic body 22. The FFC 21 electrically connects the vehicle body side and the slide door 5. The slide door 5 has the slide portion 7 guided by the step side guide unit 43 provided on the vehicle body side. The FFC 21 crosses the trajectory space 14 through which the slide portion 7 passes. The plate-shaped elastic body 22 is disposed along the FFC 21.

The cross-sectional shape of the plate-shaped elastic body 22 in a cross section orthogonal to the extending direction of the FFC 21 is a curved shape in which the first surface 22a is a concave surface. Both end portions of the plate-shaped elastic body 22 are held such that the first curved portion 26 is formed at the part of the plate-shaped elastic body 22 crossing the trajectory space 14. In the plate-shaped elastic body 22, the second curved portion 28 is generated while the slide door 5 moves from one to the other of the fully closed position and the fully open position. The plate-shaped elastic body 22 of the present embodiment is held such that the vehicle body side second curved portion 28A is generated in the plate-shaped elastic body 22 while the slide door 5 moves from the fully open position to the fully closed position. In addition, the plate-shaped elastic body 22 is held such that the door side second curved portion 28B is generated in the plate-shaped elastic body 22 while the slide door 5 moves from the fully closed position to the fully open position.

In the first curved portion 26, the plate-shaped elastic body 22 is curved with the first surface 22a as the outer peripheral surface when viewed from the vehicle upward-downward direction. In the second curved portion 28, the plate-shaped elastic body 22 is curved with the first surface 22a as the inner peripheral surface when viewed from the vehicle upward-downward direction. By the plate-shaped elastic body 22 being curved with the first surface 22a as the inner peripheral surface in the second curved portion 28, no sound is likely to be generated when the second curved portion 28 is generated. In addition, no sound is likely to be generated when the second curved portion 28 linearly deforms. Therefore, according to the slide door routing structure 1 of the present embodiment, quietness during opening and closing of the slide door 5 is improved.

The slide door routing structure 1 of the present embodiment has a plurality of the plate-shaped elastic bodies 22. Each of the plurality of plate-shaped elastic bodies 22 overlaps each other. The number N of stacked plate-shaped elastic bodies 22 is determined based on, for example, the plate thickness t and the curvature radius r1 of the plate-shaped elastic body 22 and the bending radius R1 of the plate-shaped elastic body 22 in the first curved portion 26. By overlapping the plurality of plate-shaped elastic bodies 22, it is possible to realize, for example, a desired bending radius R1 while ensuring necessary durability.

The slide door routing structure 1 of the present embodiment has the FFCs 21 overlapping each other as conductors. The FFC 21 is an example of a flat cable. In the wire harness WH, the plurality of overlapping FFCs 21 and the plurality of overlapping plate-shaped elastic bodies 22 are disposed to face each other. By overlapping the plurality of flat cables, it is possible to reduce the bending radius of the wire harness WH.

The slide door routing structure 1 of the present embodiment further has the partition wall 46 extending along the step side guide unit 43 and facing the plate-shaped elastic body 22. The plate-shaped elastic body 22 is held so as to be pressed toward the partition wall 46. The partition wall 46 has the curved surface 46d that is convex toward the plate-shaped elastic body 22 when viewed from the vehicle upward-downward direction. The vehicle body side second curved portion 28A is generated by the plate-shaped elastic body 22 being bent along the curved surface 46d. By the curved surface 46d being provided, the plate-shaped elastic body 22 can be bent in a desired direction of curvature. In other words, by the plate-shaped elastic body 22 being pressed toward the curved surface 46d, bending deformation of the plate-shaped elastic body 22 proceeds smoothly. In addition, since the plate-shaped elastic body 22 is pressed against the partition wall 46, vibration and noise are unlikely to occur in the plate-shaped elastic body 22. Therefore, the partition wall 46 is capable of suppressing sound generation during bending deformation of the plate-shaped elastic body 22.

The slide door routing structure 1 of the present embodiment has the door side holding unit 2 disposed on the slide door 5 and holding the slide door 5 side end portion of the plate-shaped elastic body 22. The plate-shaped elastic body 22 extends from the door side holding unit 2 toward the vehicle body side. Since the plate-shaped elastic body 22 extends toward the vehicle body side, the door side second curved portion 28B is generated between the door side holding unit 2 and the first curved portion 26. In addition, since the plate-shaped elastic body 22 extends toward the vehicle body side, the plate-shaped elastic body 22 is pressed toward the partition wall 46.

In the slide door routing structure 1 of the present embodiment, the first curved portion 26 is formed in the trajectory space 14 and the part of the wire harness WH connected to the first curved portion 26 extends along the partition wall 46, and thus the extra length part generated in the wire harness WH is mainly accommodated in the trajectory space 14. Accordingly, the extra length part of the wire harness WH can be accommodated without a dedicated space being provided anew. In other words, a dedicated space for routing the wire harness WH can be reduced. The first curved portion 26 moves in the same direction as the lower arm 6 in accordance with the movement of the lower arm 6 in the vehicle forward-rearward direction. Therefore, the extra length part of the wire harness WH is accommodated in the trajectory space 14 without interfering with the slide portion 7.

The partition wall 46 of the present embodiment is disposed along the guide unit 11 and functions as a regulating unit regulating a deviation of the first curved portion 26 from the trajectory space 14. The partition wall 46 supports the wire harness WH from the vehicle body middle side and regulates a deviation of the first curved portion 26 from the trajectory space 14 to the vehicle body middle side. Therefore, the partition wall 46 is capable of reducing a dedicated space for routing the wire harness WH.

### First Modification Example of Embodiment

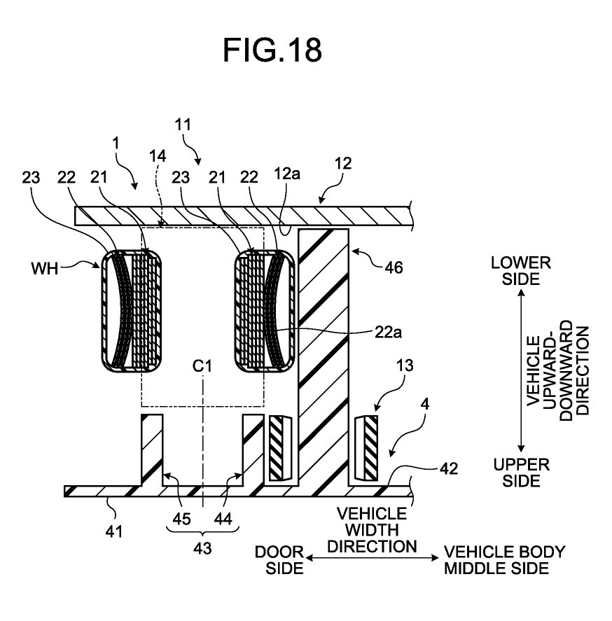

A first modification example of the embodiment will be described below. FIG. 18 is a cross-sectional view of a wire harness according to the first modification example of the embodiment. As illustrated in FIG. 18, in the wire harness WH according to the first modification example, the positional relationship between the FFC 21 and the plate-shaped elastic body 22 is different from that according to the embodiment described above. Specifically, the plate-shaped elastic body 22 is positioned outside the FFC 21. In other words, the plate-shaped elastic body 22 of the first modification example is disposed so as to be positioned on the curvature direction outer side with respect to the FFC 21 in the first curved portion 26.

The plate-shaped elastic body 22 holds the FFC 21 from the outside in the first curved portion 26, and thus the shape of the first curved portion 26 is stabilized with ease. The plate-shaped elastic body 22 has a moderate rigidity to be capable of holding the FFC 21. Therefore, the plate-shaped elastic body 22 disposed outside the FFC 21 is capable of suitably preventing the FFC 21 from bulging outwards beyond a desired shape. In addition, the plate-shaped elastic body 22 disposed outside the FFC 21 protects the FFC 21 like a protector. For example, the plate-shaped elastic body 22 is capable of protecting the FFC 21 from impact even if the wire harness WH comes into contact with another component.

### Second Modification Example of Embodiment

A second modification example of the embodiment will be described below. The flexible conductor is not limited to the FFC 21 and may also be a linear coated electric wire or an electric wire that has another shape. The plate-shaped elastic body 22 is not limited to a metal plate and may also be made of another material such as a synthetic resin. The exterior package 23 may also be, for example, a rubber tube insofar as the conductor and the plate-shaped elastic body 22 can be accommodated and held in the exterior package 23. The exterior package 23 may also be a resin fiber-knitted tubular elastic member having a contraction and expansion property. Means that extends the plate-shaped elastic body 22 along the conductor is not limited to the exterior package 23. Various members fixing the plate-shaped elastic body 22 to the conductor in a state of extending along the conductor can be used. The plate-shaped elastic body 22 may be fixed to the conductor by means such as adhesion and binding.

The first curved portion 26 of the above embodiment is curved toward the vehicle front side. Alternatively, a first curved portion 26 curved toward the vehicle rear side may be formed in the plate-shaped elastic body 22. In this case, it is preferable that each of the vehicle body side holding unit 3 and the door side holding unit 2 holds the wire harness WH so as to extend the wire harness WH toward the vehicle rear side.

The contents disclosed in the above-described embodiment and modification examples can be executed in appropriate combination.

A slide door routing structure according to the present embodiment includes a flexible conductor electrically connecting a vehicle body side and a slide door having a slide portion guided by a guide unit provided on the vehicle body side and crossing a trajectory space through which the slide portion passes, and a plate-shaped elastic body disposed along the conductor. A cross-sectional shape of the plate-shaped elastic body in a cross section orthogonal to an extending direction of the conductor is a curved shape in which a first surface as a surface on one side is a concave surface. Both end portions of the plate-shaped elastic body are held such that a first curved portion is formed at a part of the plate-shaped elastic body crossing the trajectory space.

A second curved portion different from the first curved portion is generated in the plate-shaped elastic body while the slide door moves from one to the other of a fully closed position and a fully open position. The plate-shaped elastic body is curved with the first surface as an outer peripheral surface when viewed from a vehicle upward-downward direction in the first curved portion and the plate-shaped elastic body is curved with the first surface as an inner peripheral surface when viewed from the vehicle upward-downward direction in the second curved portion. In the slide door routing structure according to the present embodiment, the direction of curvature of the second curved portion is a direction in which bending resistance is small in the plate-shaped elastic body. Accordingly, no sound is likely to be generated with the generation of the second curved portion and a quietness improvement effect can be achieved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A slide door routing structure comprising:
a flexible conductor that electrically connects a vehicle body side and a slide door having a slide portion guided by a guide unit provided on the vehicle body side, and crosses a trajectory space through which the slide portion passes; and
a plate-shaped elastic body disposed along the conductor, wherein
a cross-sectional shape of the plate-shaped elastic body in a cross section orthogonal to an extending direction of the conductor is a curved shape in which a first surface as a surface on one side is a concave surface,
both end portions of the plate-shaped elastic body are held such that a first curved portion is formed at a part of the plate-shaped elastic body crossing the trajectory space,
a second curved portion different from the first curved portion is generated in the plate-shaped elastic body while the slide door moves from one to the other of a fully closed position and a fully open position, and
the plate-shaped elastic body is curved with the first surface as an outer peripheral surface when viewed from a vehicle upward-downward direction in the first curved portion, and the plate-shaped elastic body is curved with the first surface as an inner peripheral surface when viewed from the vehicle upward-downward direction in the second curved portion.

2. The slide door routing structure according to claim 1, further comprising:
a plurality of the plate-shaped elastic bodies, wherein
each of the plurality of plate-shaped elastic bodies overlaps each other.

3. The slide door routing structure according to claim 2, further comprising:
a plurality of flat cables that overlap each other as the conductor, wherein
the plurality of the overlapped flat cables and the plurality of the overlapped plate-shaped elastic bodies are disposed so as to face each other.

4. The slide door routing structure according to claim 1, further comprising:
a wall portion that extends along the guide unit and faces the plate-shaped elastic body, wherein
the plate-shaped elastic body is held so as to be pressed toward the wall portion,
the wall portion has a curved surface convex toward the plate-shaped elastic body when viewed from the vehicle upward-downward direction, and
the second curved portion is generated by the plate-shaped elastic body bending along the curved surface.

5. The slide door routing structure according to claim 2, further comprising:
a wall portion that extends along the guide unit and faces the plate-shaped elastic body, wherein
the plate-shaped elastic body is held so as to be pressed toward the wall portion,
the wall portion has a curved surface convex toward the plate-shaped elastic body when viewed from the vehicle upward-downward direction, and
the second curved portion is generated by the plate-shaped elastic body bending along the curved surface.

6. The slide door routing structure according to claim 3, further comprising:
a wall portion that extends along the guide unit and faces the plate-shaped elastic body, wherein
the plate-shaped elastic body is held so as to be pressed toward the wall portion,
the wall portion has a curved surface convex toward the plate-shaped elastic body when viewed from the vehicle upward-downward direction, and
the second curved portion is generated by the plate-shaped elastic body bending along the curved surface.

7. The slide door routing structure according to claim 1, further comprising:
a door side holding unit that is disposed on the slide door and holds an end portion of the plate-shaped elastic body on the slide door side, wherein
the plate-shaped elastic body extends from the door side holding unit toward the vehicle body side.

8. The slide door routing structure according to claim 2, further comprising:
a door side holding unit that is disposed on the slide door and holds an end portion of the plate-shaped elastic body on the slide door side, wherein
the plate-shaped elastic body extends from the door side holding unit toward the vehicle body side.

9. The slide door routing structure according to claim 3, further comprising:
a door side holding unit that is disposed on the slide door and holds an end portion of the plate-shaped elastic body on the slide door side, wherein
the plate-shaped elastic body extends from the door side holding unit toward the vehicle body side.

10. The slide door routing structure according to claim 4, further comprising:
a door side holding unit that is disposed on the slide door and holds an end portion of the plate-shaped elastic body on the slide door side, wherein
the plate-shaped elastic body extends from the door side holding unit toward the vehicle body side.

11. The slide door routing structure according to claim 5, further comprising:
a door side holding unit that is disposed on the slide door and holds an end portion of the plate-shaped elastic body on the slide door side, wherein
the plate-shaped elastic body extends from the door side holding unit toward the vehicle body side.

12. The slide door routing structure according to claim 6, further comprising:
a door side holding unit that is disposed on the slide door and holds an end portion of the plate-shaped elastic body on the slide door side, wherein
the plate-shaped elastic body extends from the door side holding unit toward the vehicle body side.
